(19) United States
(12) Patent Application Publication
(10) Pub. No.: US 2007/0219849 A1
(43) Pub. Date: Sep. 20, 2007

(54) AUTOMATED METHOD, SYSTEM, AND PROGRAM FOR GENERATION OF AN AUDIO SURVEY

(75) Inventors: Eric Edwards, West Henrietta, NY (US); Christopher Mann, Pittsford, NY (US); Jacqueline Parks, Honeoye Falls, NY (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(73) Assignee: Voiceport, LLC

(21) Appl. No.: 11/564,288

(22) Filed: Nov. 28, 2006

Related U.S. Application Data
(60) Provisional application No. 60/740,177, filed on Nov. 28, 2005.
(60) Provisional application No. 60/740,182, filed on Nov. 28, 2005.

(51) Int. Cl. G07G 1/00

(52) U.S. Cl. 705/10

(57) ABSTRACT

The disclosed subject matter involves method and system for creating a survey for clients to be administered to third parties. The client provides information as to the survey parameters. The survey is placed in an automated audio format and administered to third parties. Options available include the use of a knowledge base that allows a structure to aid in survey generation. Vocal personas are used that make the surveys easier to use and seem more creditable.

This application claims the benefit of priority to U.S. Provisional Patent Application No. 60/740,177 entitled “PERSONA-DRIVEN METHOD FOR COMPILING ADVERTISING DATA USING VOICE INTERFACE SYSTEM,” by Eric Edwards filed on Nov. 28, 2005, and is incorporated herein by reference as if fully set forth herein. This application also claims the benefit of priority to U.S. Provisional Patent Application No. 60/740,182 entitled “METHOD FOR COMPILING ADVERTISING DATA USING VOICE INTERFACE SYSTEM,” by Eric Edwards filed on Nov. 28, 2005, and is incorporated herein by reference as if fully set forth herein.

This application incorporates by reference the co-pending patent application entitled “AUTOMATED METHOD, SYSTEM, AND PROGRAM FOR AIDING IN PRODUCT ADVERTISEMENT”, by Eric Edwards filed on Nov. 28, 2006, and is incorporated herein by reference as if fully set forth herein.

This application incorporates by reference the co-pending patent application entitled “AUTOMATED METHOD, SYSTEM, AND PROGRAM FOR AIDING IN STRATEGIC MARKETING”, by Eric Edwards filed on Nov. 28, 2006, and is incorporated herein by reference as if fully set forth herein.

This application incorporates by reference the co-pending patent application entitled “AUTOMATED METHOD, SYSTEM, AND PROGRAM FOR AIDING IN PRODUCT COMPLIANCE AND ADHERENCE”, by Eric Edwards filed on Nov. 28, 2006, and is incorporated herein by reference as if fully set forth herein.

### TECHNICAL FIELD OF THE INVENTION

The disclosed subject matter relates to the generation of an audio survey over a computer based application. More specifically, the disclosed subject matter deals with using a computer based application to take inputs from a client and turn those inputs into a survey conducted over a telephone. The disclosed subject matter also receives inputs from those surveyed and allows the client to access the information collected.

### BACKGROUND OF THE INVENTION

Many business and organizations are interested in what third parties think about various issues. These issues range from what products third parties want to buy to who third parties want to elect for public office. Whatever the reason for the survey, the market exists for such data collection. Data collection can occur in different ways. The answers to survey question can also be collected by mail or e-mail formatted surveys. Pollsters can conduct similar surveys in person.

One of the most common ways of collecting information comes from use of the telephone. Due to the prevalence of the telephone, surveys taken though telephones and reach a large cross section of the population. Such surveys can be conducted from a central location on individuals who are geographically distant from the survey taker.

A drawback with such telephone surveys comes from the large number of staff necessary to conduct the survey. The more people used to conduct the survey, the more comprehensive the survey. The question becomes an one of expense. The client can conduct the survey themselves, but that requires a commitment of time and personnel that could be used on other projects. The company could delegate the survey out to an independent contractor who is equipped to handle such a survey, but that could become cost prohibitive.

With this background, there exists a need for a way to conduct surveys over the telephone in such a manner that can accomplish the survey with a minimal amount of work and expense on the part of the client.

The disclosed subject matter involves method and system for creating a survey for clients to be administered to third parties. The client provides information as to the survey parameters. The survey is placed in an automated audio format and administered to third parties. Options available include the use of a knowledge base that allows a structure to aid in survey generation. Vocal personas are used that make the surveys easier to use and seem more creditable.

### SUMMARY OF THE INVENTION

The method and system illustrated and described herein have several features, no single one of which is solely responsible for its desirable attributes. Without limiting the scope as expressed by the description that follows, its more prominent features will now be discussed briefly. After considering this discussion, and particularly after reading the section entitled “DETAILED DESCRIPTION OF THE ILLUSTRATIVE EMBODIMENTS” one will understand how the features of the disclosed subject matter provide for the analysis of source code.

The disclosed subject matter involves method and system for creating a survey for clients to be administered to third parties. The client provides information as to the survey parameters. The survey is placed in an automated audio format and administered to third parties. Options available include the use of a knowledge base that allows a structure to aid in survey generation. Vocal personas are used that make the surveys easier to use and seem more creditable.

A component of the disclosed subject matter involves defining the survey to administer to third parties. The disclosed subject matter collects the information in several ways. One method involves the client interacting with an automated system. The method and system would determine how to categorize the survey. The method and system would ask the client a series of questions to determine the content of the survey. The basis of these questions comes from commonly asked questions involved in surveys in the applicable field.

Alternatively, a personal service agent from the service provider can collect survey information to craft a unique survey. Customization allows the client greater flexibility in the service. Other alternatives include the client creating their own surveys and having the service provider simply provide the delivery vehicle.

The questions used to generate the survey are progressively narrow in focus. Once the board questions are asked, narrower questions are asked based on the response to previous questions. These questions continue until either the client wishes to stop or until known questions parameters are exhausted.

Upon establishing the content of the surveys, the system processes the content into an audio format with a particular persona. An example would include a stereotypical mechanic with perhaps some garage sounds in the background if the product deals with automotive issues. Another example would use a nurse at a hospital asking health related questions, as in the case of a pharmaceutical product. There would be no limit to the number of personas available. Other alternatives allow the voice used in the calls to come from a particular voice actor as opposed to a standard voice offered by the service provider.

Now that the survey is created, the applicable third parties need to be in contact with the service provider to receive the survey. The third party can receive the contact information in any possible format. Available choices include a personal contact from a client representative or through direct mail to give the third parties the contact information for the service provider. In other embodiments, the service provider could also initiate contact with the third party.

In this embodiment, once the third party contacts the service provider, there are two possibilities in the current embodiment. First, the service provider number called might only have one survey associated with it. In that case, the survey will administer the applicable survey. Secondly, the service provider could advertise more than one survey available at that contact number, but the third party selects the survey. The applicable survey is dispensed when selected.

A factor that can be considered when generating the survey is the length of the survey. The disclosed subject matter will approximate how long each survey will take. This could be a relevant factor for cost purposes or for optimum use of the survey. One embodiment of the disclosed subject matter can offer the survey service by charging per minute of phone time used in the survey. The client might want to consider the trade off of getting a more detailed survey with fewer samples or a more general survey with more samples.

As the survey is executed, the client can have access to the results in real time. Rather than having to wait for the response to be input into a computer by the survey administrator, the response from the surveyed automatically enters a computer allowing real time analysis.

### BRIEF DESCRIPTION OF DRAWINGS

The accompanying drawings, which are incorporated in and constitute a part of this specification, illustrate several embodiments of the invention and together with the description, serve to explain the principles of the invention.

FIG. 1 presents a general overview of the disclosed subject matter. The survey information is collected by the service provider from the client to define the survey. The service provider then is placed in contact with t e third party. The service provider administers the survey to the third party;

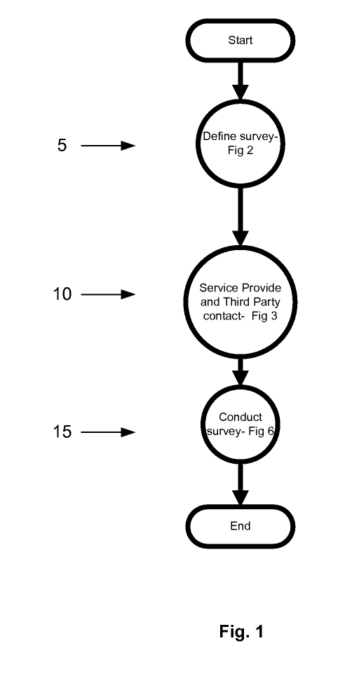

FIG. 2 shows the mechanics of using an automated system for survey generation. The information is collected by the service provider from the client and converted into an automated survey of an appropriate type;

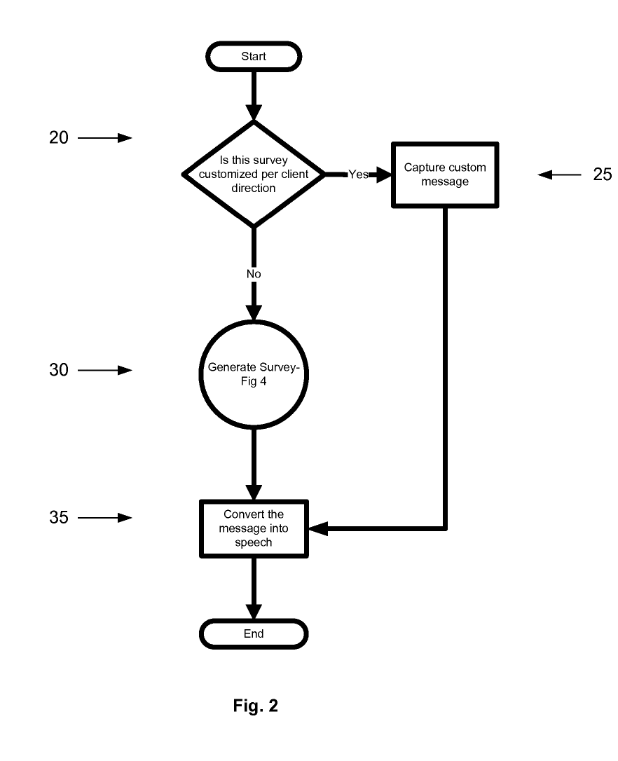

FIG. 3 depicts how the service provider receives the third party contact information;

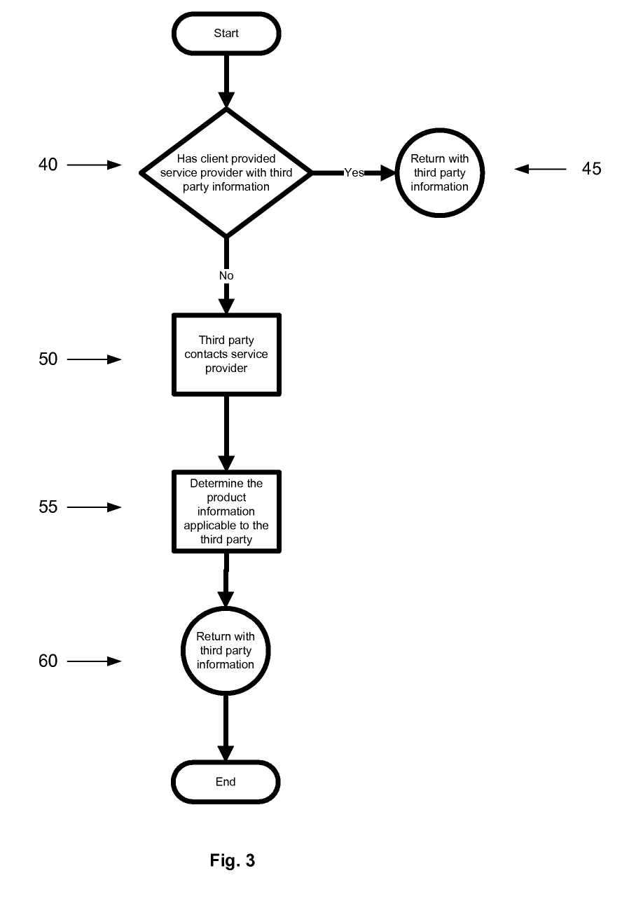

FIG. 4 is an algorithm useful for generating the survey;

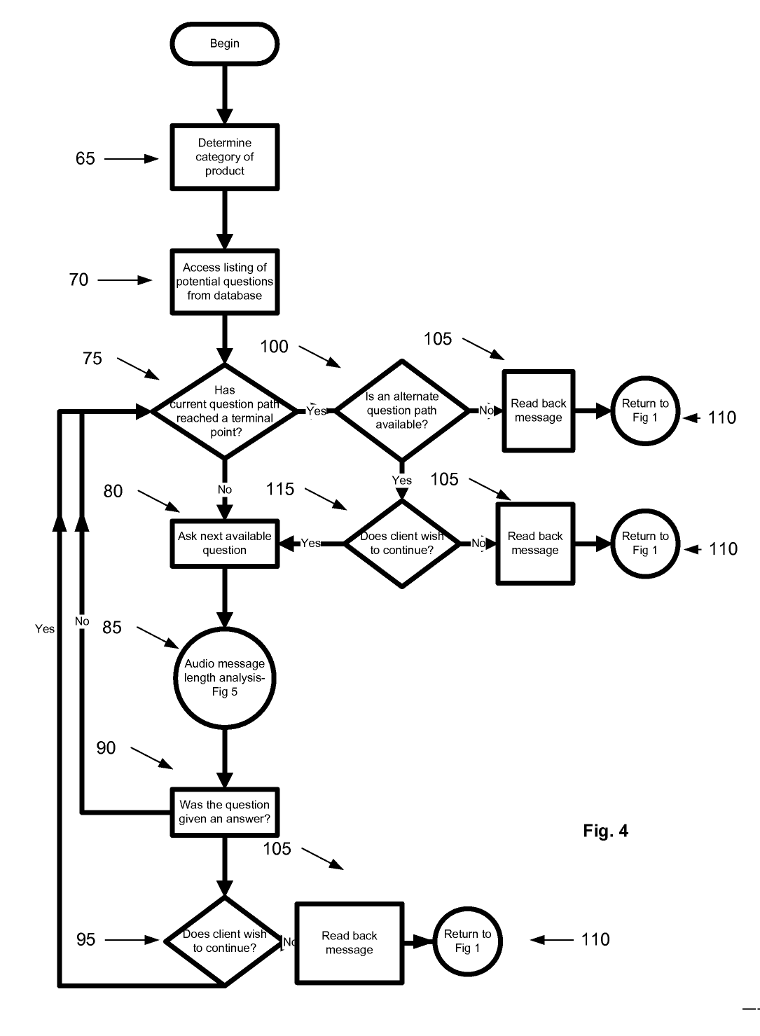

FIG. 5 provides an audio length analysis algorithm, for use in one embodiment where survey length is a factor of concern; and

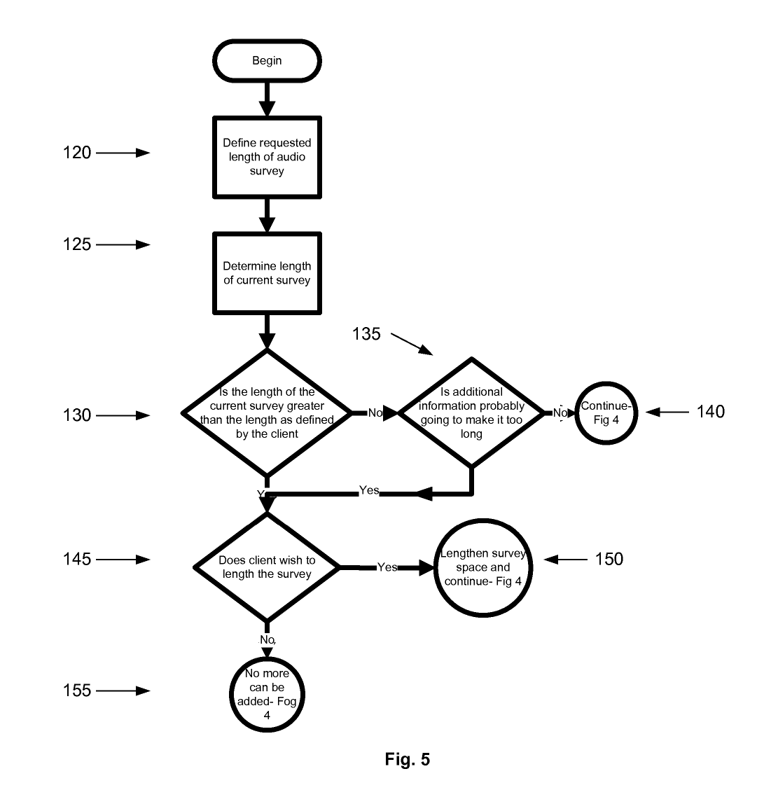

FIG. 6 shows the process of using administering the survey to the third party.

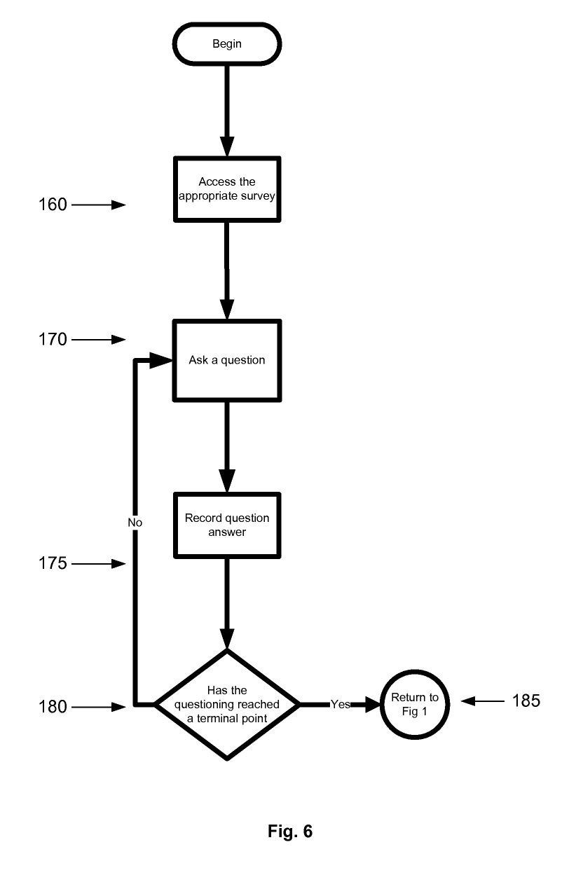

### DETAILED DESCRIPTION OF PREFERRED EMBODIMENTS

The disclosed subject matter involves method and system for creating a survey for clients to be administered to third parties. The client provides information as to the survey parameters. The survey is placed in an automated audio format and administered to third parties. Options available include the use of a knowledge base that allows a structure to aid in survey generation. Vocal personas are used that make the surveys easier to use and seem more creditable.

Although described with particular reference to a systems environment, the claimed subject matter can be implemented in a plurality of information technology (IT) systems. Those with skill in the electronic telecommunications arts will recognize that the disclosed embodiments may be realized in ways in addition to those specific examples described below. In addition, the methods of the disclosed subject matter can be implemented using a variety of combinations of software and hardware. The hardware portion can be implemented using specialized logic; the software portion can be stored in a memory and executed by a suitable instruction execution system such as a microprocessor, PC or mainframe.

All references, including publications, patent applications, and patents, cited herein are hereby incorporated by reference to the same extent as if each reference were individually and specifically indicated to be incorporated by reference and were set forth in its entirety herein.

In the context of this document, a “memory” can be any means that contains, stores, communicates, propagates, or transports the program and/or data for use by or in conjunction with an instruction execution system, apparatus or device. Memory, recording medium and data store can be, but are not limited to, an electronic, magnetic, optical, electromagnetic, infrared or semiconductor system, apparatus or device. Memory, recording medium and data store also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

The disclosed subject matter may be described in the general context of computer-executable instructions, such as program modules, being executed by a computer. Generally, program modules include routines, programs, objects, components, data structures, etc. that performs particular tasks or implement particular abstract data types. The disclosed subject matter may also be practiced in distributed computing environments wherein tasks are performed by remote processing devices that are linked through a communications network. In a distributed computing environment, program modules may be located in local and/or remote computer storage media including memory storage devices.

Preferred embodiments of this disclosed subject matter are described herein, including the best mode known to the inventors for carrying out the disclosed subject matter. Variations of those preferred embodiments may become apparent to those of ordinary skill in the art upon reading the foregoing description. The inventors expect skilled artisans to employ such variations as appropriate, and the inventors intend for the disclosed subject matter to be practiced otherwise than as specifically described herein. Accordingly, this disclosed subject matter includes all modifications and equivalents of the subject matter recited in the claims appended hereto as permitted by applicable law. Moreover, any combination of the above-described elements in all possible variations thereof is encompassed by the disclosed subject matter unless otherwise indicated herein or otherwise clearly contradicted by context.

Although the present disclosed subject matter has been described in detail herein with reference to the illustrative embodiments, it should be understood that the description is by way of example only and is not to be construed in a limiting sense. It is to be further understood, therefore, that numerous changes in the details of the embodiments of this disclosed subject matter and additional embodiments of this disclosed subject matter will be apparent to, and may be made by, persons of ordinary skill in the art having reference to this description. It is contemplated that all such changes and additional embodiments are within the spirit and true scope of this disclosed subject matter as claimed below.

The disclosed subject matter conducts a survey of third parties for the client in an audio format. This incorporates certain rules and patterns that have been observed in the structure of information collected by clients from third parties with additional intelligence from external sources. This methodology provides the algorithmic basis of survey generation along with the survey themselves. The current disclosed subject matter utilizes state of the art voice user interface techniques to provide a comfortable and intuitive interaction with the third party. Clients who would benefit from surveys can benefit from the disclosed subject matter.

The current disclosed subject matter includes a way to capture client survey generation requests and for creating an audio survey for the purpose of asking those questions and recording the responses. The disclosed subject matter gathers information about the client's questions and build surveys to receive information from third parties. The third party can receive the survey from any source, including telephone and web based systems. For example purposes, audio input generation will be used to create audio surveys, while alternatives such as a web based format are available. For example purposes, communication with third parties can use any medium, including telephone and web based systems.

In the example used in this description, the embodiment would involve a product manufacturer being a client of a service provider. Alternatively, the service can be provided by the company who want the calls made by an in-house department. Moreover, the client and the service provider can be one and the same.

The system records information to communicate to third parties 5. The disclosed subject matter uses an algorithm to generate the survey from the information provided from the client or the client can directly create the survey.

Once the client's survey is generated, the third party contacts the service provider in this example 10. The survey can be administered to third parties 15.

An aspect used in some embodiments of the disclosed subject matter to generate the questions and responses comes from the use of a database. The database contains information on what the typical client surveys ask a third party. This database can contain information for a plurality of possible survey types.

An alternative embodiment allows the client to customize their surveys by directly providing the service provider with exactly what the client wants the surveys to ask without use of the database. The alternative would allow the client the ability to select exactly what they want the surveys to say and also ask very specialized questions. Another alternative available to the client would use personal contact with the service provider. This would allow a collaborative process where both parties come up with a particular set of inputs and outputs for the surveys. If the client chooses to use a customized survey 20, the survey generated by this customized process would be the one used in the system 25. The system then converts the survey into the applicable audio format 35.

Otherwise, the service has a list of standard questions and prompts available. As the disclosed subject matter begins, the client receives a query for basic details about the product they are selling. The product classification returns a series of relevant and appropriate prompts, which ask the client to select from this list of the criteria based on the classification. The prompts over the telephone system are designed to be conversational and direct, and therefore will elicit responses that are natural to the caller and, likely to be recognized by the system. Alternatively, some responses accept input on the telephone keypad.

If the information comes from a standardized system as opposed to a customized one, the system then generates the survey per the embodiment 30. Once all of the information is collected, the system converts into the survey in audio format 35. The audio format takes on one of a number of personas. The persona used for the survey relates to the type of survey being taken. These personas suggest attributes of the speaker that foster creditability in what the survey asks. Examples include a nurse dispensing medical information, a mechanic talking about a car, a lawyer talking about legal issues, or a pollster asking about how a person plans on voting. Optional sounds include background noises, such as the sound of a hospital in the background for a nurse, or sounds of a garage for a mechanic.

An alternative to the use of a particular persona would be the use of a specified voice actor. This could allow more customization to the client.

The disclosed subject matter in the described embodiment makes contact with third parties. In some embodiments, the client might already have the applicable third party contact information and have provided it to the service provider 40. If so, no more data collection is needed 45. In the example used for illustrative purpose, the service provider does not start with the third party's contact information. In this context, the third party would have to initiate contact with the service provider in order for the service provider to get the third party contact information 50. When the third party makes contact with the service provider, the service provider determines the applicable survey to give the third party 55. This information goes to the applicable areas for communication with the client 60.

When generating the survey, the system approaches the survey generated in a predetermined manner. The following example will describe a possible algorithm used to collect information from the client. These bullets denote the information that is initially collected from the client 65 to determine categorization:
Type of survey (politics)
Type of politics (state)
Sub-classification of state politics (governor)

Next, the initially collected information is used to select a capture profile specific to the product. The capture profile consists of a series of capture items that are presented to the caller in sequence to collect additional information about the product. Examples of capture items are 70:
State
Overall approval
Approval on economy
Approval on crime prevention

The general algorithm repeats until a termination condition is met. The system will also look to see if a question remains on the capture profile 75. If so, then the system will present the next question to the client 80. After the question is asked, the system then analyzes the entire survey for audio survey length 85. If no answer to the question was given, the system goes to the next question 90. If the client does not wish to continue with the questions, the process completes with a survey read back 105 and the survey generates 110. Once a path of questions has been exhausted, the system looks to see if an alternate path of questioning exists 100. If there is no available alternate path, the system reads back the survey 105 at that time and generates the survey 110. When an alternate path exists, the system asks if the client wishes to continue 115. If so, the system continues with the new question list 80. If not, the survey is read back 105 system generates the survey 110. When the survey generation ends, the result is retuned back to the relevant portion of the system 110.

The system confirms with the client every piece of information. Failure to confirm or collect a piece of information (for example, repeatedly fails to recognize their last name) results in the caller being transferred to an agent or another alternate based on the embodiment.

An optional aspect of the disclosed subject matter relates to the cost of the service. Some embodiments of the service give the client the option to limit the cost of the service provided by making the cost of the call fall within a set price boundary 120 in embodiments that charge for the service per the amount of time for each call. In doing so, the system will define the amount of time that is applicable to that amount of money the client wants to spend. This can be used to determine if the survey can be lengthened or needs to be reduced.

The system calculates audio survey length by through use of an algorithm, converting the survey into audio format, or other method to those known in the art to determine the resulting survey length 125. Based on the returned length or the survey, the system will do one of the following:
Check the length of the survey and see if it is within the amount paid for 130
If the most recently added item has raised the price for the survey notify the client that the item does not fit 145. Read the survey text back and query if they would like to include the most recent item and possibly more in the survey and raise the limit on the price per call. If they select more 150, then the process continues. If they choose not to purchase more time per call, then the survey is concluded 155.
If there is likely additional time available at the current price quoted initially 135 move on to the next capture item 140.
If the survey does not likely have additional time at the current price 135, read the survey text and current price back to the customer and query if they would like to include more in the survey and raise the limit on the price of the call 145.

The algorithm continues until the content of the survey meets the client's requirements or all capture items have been presented. The system reads the survey back to the client for verification.

The system confirms with the client every piece of information whether it already exists or is collected new from the caller (in the case of incorrect or no information). Failure to confirm or collect a piece of information (for example, repeatedly fails to recognize their last name) results in the caller being transferred to an agent or another alternate based on the program.

Once the client's survey has been generated, the system now turns to execute the survey with the applicable third parties. In some embodiments, the client might already have the applicable third party contact information and have provided it to the service provider. In the example used for illustrative purpose, it is assumed the service provider does not start with the third party's contact information.

The impetus to call the service provider comes from any source. One example is direct mail targeting the intended third parties. Direct mail has long been a traditional method of mass survey. The mail invites the third party to follow up with a phone call to the service provider. The service provider gives the third party the pre generated survey. The same information can be made available through other periodicals.

Another way to inform the third party about the survey comes from the customer service representatives of the client. When a customer service representative contacts a prospective third parties, the representative has a very limited amount of time to communicate all the relevant information about a product. The service provider can leave a small pamphlet with the third party and instruct them about the survey.

When third parties call the service provider, there are several possibilities. One possibility is that the phone number called is dedicated to one specific survey. In that instance, the survey begins automatically. In an alternate version, there could be multiple surveys given the same survey number. The third party would have to select which survey they want to participle in.

The service provider can also collect information from the third parties for use in real time analysis from the client. The client asks the service provider results of the survey and break the information down by region, specialty, or any other measurable criteria. The information can also be collected to suggest what products clients are interested in purchasing.

When the service provider and third party make contact, the appropriate survey is accessed in the system 160. The first question in the survey list is asked 170. The answer is recorded by the system 175. The process repeats as long as there is another question in the survey 180. Once the survey questions are exhausted, the survey ends 185.

Another option for the system allows for the capture of billing information. The system checks the customer database for a matching account using the client name and number. If there is an associated account then the address in the account is confirmed with the caller. Failure to confirm the existing account address will cause the caller to go to an agent. If there is no account then the system collects the caller's address from the caller and creates a new account. In both cases, the survey is saved.

If there is no account and collecting the address for the new account fails then a new account is made with the unknown fields marked as incomplete and the survey is saved. The caller is then transferred to an agent. During the transfer, the agent is informed (via whisper) that the survey has been saved but the name and address fields are incomplete.

The disclosed subject matter described herein is a fundamentally novel method and system. By facilitating the collection of information from third parties on behalf of clients, a service provider can aid a client in collecting information. Following a standardized algorithm, the surveys are generated in a manner that facilitates easy communication with the client and effectively receives information from the third parties.

Various changes and modification to the embodiments herein were chosen for the purposes of illustration will readily occur to those skilled in the art. To the extent that such modifications and variations do not depart form the spirit of the invention, they are intended to be included within the scope thereof which is assessed only by fair interpretation of the following claims.

What is claimed is:

1. A method of creating an audio survey by way of an automated communications system, comprising the steps of:
creating a survey based on client input;
executing said survey on a third party in an audio format; and
recording survey response from a third party.

2. The method of claim 1 for creating an audio survey, further comprising the steps of:
accessing a knowledge base; and
asking the client questions based on the contents of said knowledge base.

3. The method of claim 2 where said knowledge base selected comes from a plurality of knowledge bases based on user input.

4. The method of claim 2 where the basis of subsequent questions come from the responses to previous questions.

5. The method from claim 4 where basis of said survey comes from responses to preliminary questions and subsequent detailed questions asked.

6. The method of claim 2 where said knowledge base directs the vocal persona used.

7. The method of claim 1 further comprising the step of compiling said customer survey responses in the automated system for real-time analysis by the client.

8. The method of claim 1 further comprising the step of converting the survey into an audio format with a predetermined vocal persona.

9. A system of creating an audio survey by way of an automated communications system, comprising:
a general purpose computer capable of executing a portion of instruction set of a software product;
a software product where the software product controls a general purpose computer performing the following instruction sets:
a set of instructions to access a knowledge base;
a set of instructions to ask the client questions;
a set of instructions to create a survey based on responses to said questions asked;
a set of instructions to convert the survey into an audio format with a predetermined vocal persona;
a set of instructions to execute said survey to a third party in an audio format; and
a set of instructions to record survey response from a third party.

10. A system of claim 9 for creating an audio survey, where the software product further comprising
a set of instructions to access a knowledge base; and
a set of instructions to as the client questions based on the contents of said knowledge base.

11. The system of claim 10 where said system contains instructions for selecting said knowledge base from a plurality of knowledge bases based on user input.

12. The system of claim 10 where said system contains instructions for selecting subsequent questions based on said responses to previous questions.

13. The system from claim 12 where basis of said survey comes from responses to preliminary questions and subsequent detailed questions asked.

14. The system of claim 10 where said system contains instructions for said knowledge base directs the vocal persona used.

15. The system of claim 9 where said system contains instructions for compiling said customer survey responses in the automated system for real-time analysis by the client.

16. The system of claim 9 where said system contains instructions for converting the survey into an audio format with a predetermined vocal persona.

17. A computer usable medium having a computer readable program code means embodied therein for creating an audio survey by way of an automated communications system, the computer usable medium comprising:
a computer readable program code means for performing a set of instructions to access a knowledge base associated with the type of communicated information;
a computer readable program code means for performing a set of instructions to ask the client questions;
a computer readable program code means for performing a set of instructions to create a survey based on responses to said preliminary questions and detailed questions asked;
a computer readable program code means for performing a set of instructions to convert the survey into an audio format with a predetermined vocal persona;
a computer readable program code means for performing a set of instructions to execute said survey on a third party in an audio format; and
a computer readable program code means for performing a set of instructions to record survey responses from a third party.

18. A computer usable medium of claim 17, further comprising:
a computer readable program code means for accessing a knowledge base; and
a computer readable program code means of asking the client question based on the contents of said knowledge.

19. The computer usable medium of claim 18 where said knowledge base selected comes from a plurality of knowledge bases based on user input.

20. The computer usable medium of claim 18 where the basis of subsequent questions come from the responses to previous questions.

21. The computer usable medium from claim 20 where basis of said survey comes from responses to preliminary questions and subsequent detailed questions asked.

22. The computer usable medium of claim 18 where said knowledge base directs the vocal persona used.

23. The computer usable medium of claim 17 where a compiling of said third party survey question responses in the automated system enables real-time analysis by the client.

24. The computer usable medium of claim 17 where said survey converts into an audio format with a predetermined vocal persona.

25. A method of creating an audio survey, comprising the steps of:
creating a survey based end user's input, wherein the end user is targeted to be contacted based on predetermined criteria;
executing said survey created for the end user in an audio format; and
recording results of survey execution.

26. The method of claim 25 for creating an audio survey, further comprising the steps of:
accessing a knowledge base; and
asking questions to use in the survey based on the contents of said knowledge base.

27. The method of claim 26 where said knowledge base selected comes from a plurality of knowledge bases based on user input.

28. The method of claim 26 where the basis of subsequent questions come from the responses to previous questions.

29. The method from claim 28 where basis of said survey comes from responses to preliminary questions and subsequent detailed questions asked.

30. The method of claim 26 where said knowledge base directs the vocal persona used.

31. The method of claim 25 further comprising the step of compiling said customer survey responses in the automated system for real-time analysis.

32. The method of claim 25 further comprising the step of converting the survey into an audio format with a predetermined vocal persona.

33. A system of creating an audio survey by way of an automated communications system, comprising:
a general purpose computer capable of executing a portion of instruction set of a software product;
a software product where the software product controls a general purpose computer performing the following instruction sets:
a set of instructions to creating a survey based end user's input, wherein the end user is targeted to be contacted based on predetermined criteria;
a set of instructions to executing said survey created for the end user in an audio format; and
a set of instructions to recording results of survey execution.

34. A system of claim 33 for creating an audio survey, where the software product further comprising
accessing a knowledge base; and
asking questions to use in the survey based on the contents of said knowledge base.

35. The system of claim 34 where said system contains instructions for selecting said knowledge base from a plurality of knowledge bases based on user input.

36. The system of claim 34 where said system contains instructions for selecting subsequent questions based on said responses to previous questions.

37. The system from claim 36 where basis of said survey comes from responses to preliminary questions and subsequent detailed questions asked.

38. The system of claim 34 where said system contains instructions for said knowledge base directs the vocal persona used.

39. The system of claim 33 where said system contains instructions for compiling said customer survey responses in the automated system for real-time analysis.

40. The system of claim 33 where said system contains instructions for converting the survey into an audio format with a predetermined vocal persona.

41. A computer usable medium having a computer readable program code means embodied therein for creating an audio survey by way of an automated communications system, the computer usable medium comprising:
a computer readable program code means for creating a survey based end user's input, wherein the end user is targeted to be contacted based on a predetermined criteria;
a computer readable program code means for executing said survey created for the end user in an audio format; and
a computer readable program code means for recording results of survey execution.

42. A computer usable medium of claim 41, further comprising:
a computer readable program code means for accessing a knowledge base; and
a computer readable program code means for asking questions to use in the survey based on the contents of said knowledge base.

43. The computer usable medium of claim 42 where said knowledge base selected comes from a plurality of knowledge bases based on user input.

44. The computer usable medium of claim 42 where the basis of subsequent questions come from the responses to previous questions.

45. The computer usable medium from claim 44 where basis of said survey comes from responses to preliminary questions and subsequent detailed questions asked.

46. The computer usable medium of claim 42 where said knowledge base directs the vocal persona used.

47. The computer usable medium of claim 41 where a compiling of said third party survey question responses in the automated system enables real-time analysis.

48. The computer usable medium of claim 41 where said survey converts into an audio format with a predetermined vocal persona.
